(19) United States
(12) Patent Application Publication
(10) Pub. No.: US 2010/0158762 A1
(43) Pub. Date: Jun. 24, 2010

(54) IONIC LIQUID SYSTEM FOR AN ISOPARAFFIN/OLEFIN ALKYLATION

(75) Inventors: Howard S. Lacheen, Richmond, CA (US); Saleh Elomari, Fairfield, CA (US)

Correspondence Address: CHEVRON CORPORATION, P.O. BOX 6006, SAN RAMON, CA, 94583-0806, US

(73) Assignee: Chevron U.S.A., Inc.

(21) Appl. No.: 12/646,425

(22) Filed: Dec. 23, 2009

Related U.S. Application Data
(62) Division of application No. 12/335,487, filed on Dec. 15, 2008.

(51) Int. Cl. B01J 8/00; B01J 31/06

(52) U.S. Cl. 422/129; 502/159

(57) ABSTRACT

There is provided an ionic liquid system for isoparaffin/olefin alkylation, comprising a quaternary ammonium chloroaluminate, a conjunct polymer, and a hydrogen chloride. The ionic liquid system has a molar ratio of Al to N from 2.1 to 8.0. Less than 0.1 wt % AlCl₃ precipitates from the ionic liquid system when it is held for three hours or longer at or below 25° C. There is also provided an alkylation reactor comprising an ionic liquid catalyst comprising an ammonium chloroaluminate salt, and having a molar ratio of Al to N greater than 2.0, when the ionic liquid catalyst is held at a temperature at or below 25° C. for at least two hours. There is also provided an alkylation reactor comprising an ionic liquid catalyst comprising an alkyl-pyridinium haloaluminate and an impurity.

This application is a divisional of the patent application titled “An Ionic Liquid Catalyst Having a High Molar Ratio of Aluminum to Nitrogen”, application Ser. No. 12/335,487, filed on Dec. 15, 2008, herein incorporated by reference in its entirety.

This application is related to a co-filed patent application with the attorney docket number of T-7351-D2 and titled “AN IONIC LIQUID CATALYST COMPRISING AN ALKYL-PYRIDINIUM HALOALUMINATE AND AN IMPURITY”, herein incorporated by reference in its entirety.

This application is also related to the patent application titled “Process to Make a Liquid Catalyst Having a High Molar Ratio of Aluminum to Nitrogen”, application Ser. No. 12/335,494, filed on Dec. 15, 2008; and it is also related to the patent application titled “A Process for Hydrocarbon Conversion Using, A Method to Make, and Compositions of, an Acid Catalyst,” application Ser. No. 12/335,476, filed on Dec. 15, 2008; both herein incorporated by reference in their entireties.

### FIELD OF THE INVENTION

This invention is directed to ionic liquid systems for isoparaffin/olefin alkylation.

### DETAILED DESCRIPTION OF THE INVENTION

An ionic liquid catalyst comprising an ammonium chloroaluminate salt is provided. The ionic liquid catalyst has a molar ratio of Al to N greater than 2.0, when the ionic liquid catalyst is held at a temperature at or below 25° C. for at least two hours.

There is also provided an ionic liquid catalyst comprising an alkyl-pyridinium haloaluminate and an impurity, wherein the ionic liquid catalyst has a molar ratio of Al to N greater than 2.0 when the ionic liquid catalyst is held at a temperature at or below 25° C. for at least two hours.

In a third embodiment, there is provided an ionic liquid system for isoparaffin/olefin alkylation, comprising a quaternary ammonium chloroaluminate, a conjunct polymer, and a hydrogen chloride. The ionic liquid system has a molar ratio of Al to N from 2.1 to 8.0. Less than 0.1 wt % AlCl₃ precipitates from the ionic liquid system when it is held for three hours or longer at 25° C. or lower.

### Definitions

The term “comprising” means including the elements or steps that are identified following that term, but any such elements or steps are not exhaustive, and an embodiment may include other elements or steps.

“Ionic liquids” are liquids whose make-up is comprised of ions as a combination of cations and anions. The most common ionic liquids are those prepared from organic-based cations and inorganic or organic anions. Ionic liquid catalysts are used in a wide variety of reactions, including Friedel-Crafts reactions.

“Alkyl” means a linear saturated hydrocarbon of one to nine carbon atoms or a branched saturated hydrocarbon of three to twelve carbon atoms. In one embodiment, the alkyl groups are methyl. Examples of alkyl groups include, but are not limited to, groups such as methyl, ethyl, n-propyl, isopropyl, n-butyl, isobutyl, sec-butyl, t-butyl, n-pentyl, and the like.

### Ionic Liquid Catalyst:

The ionic liquid catalyst is composed of at least two components which form a complex. To be effective at alkylation the ionic liquid catalyst is acidic. The ionic liquid catalyst comprises a first component and a second component. The first component of the catalyst will typically comprise a Lewis acid compound. Lewis acids that are useful for alkylations include, but are not limited to, aluminum halides, gallium halides, indium halides, iron halides, tin halides and titanium halides. In one embodiment the first component is aluminum halide or gallium halide. For example, aluminum trichloride (AlCl₃) may be used as the first component for preparing the ionic liquid catalyst.

The second component making up the ionic liquid catalyst is an organic salt or mixture of salts. These salts may be characterized by the general formula Q+A−, wherein Q+ is an ammonium, phosphonium, or sulfonium cation and A− is a negatively charged ion such as Cl⁻, Br⁻, ClO₄⁻, NO₃⁻, BF₄⁻, BCl₄⁻, PF₆⁻, SbF₆⁻, AlCl₄⁻, Al₂Cl₇⁻, Al₃Cl₁₀⁻, AlF₆⁻, TaF₆⁻, CuCl₂⁻, FeCl₃⁻, SO₃CF₃⁻, and 3-sulfurtrioxyphenyl. In one embodiment the second component is selected from those having quaternary ammonium halides containing one or more alkyl moieties having from about 1 to about 9 carbon atoms, such as, for example, trimethylammonium hydrochloride, methyltributylammonium, 1-butylpyridinium, or alkyl substituted imidazolium halides, such as for example, 1-ethyl-3-methyl-imidazolium chloride.

In one embodiment the Al is in the form of AlCl₃ and the N is in the form of R₄N⁺X⁻ or R₃NH⁺X⁻, where R is an alkyl group and X is a halide. Examples of suitable halides are chloride, bromide, and iodide.

In one embodiment the ionic liquid catalyst is a quaternary ammonium chloroaluminate ionic liquid having the general formula RR′R″NH⁺Al₂Cl₇⁻, wherein RR′ and R″ are alkyl groups containing 1 to 12 carbons. Examples of quaternary ammonium chloroaluminate ionic liquids are an N-alkyl-pyridinium chloroaluminate, an N-alkyl-alkylpyridinium chloroaluminate, a pyridinium hydrogen chloroaluminate, an alkyl pyridinium hydrogen chloroaluminate, a di-alkyl-imidazolium chloroaluminate, a tetra-alkyl-ammonium chloroaluminate, a tri-alkyl-ammonium hydrogen chloroaluminate, or a mixture thereof.

The presence of the first component should give the ionic liquid a Lewis or Franklin acidic character. Generally, the greater the mole ratio of the first component to the second component, the greater is the acidity of the ionic liquid mixture.

For example, a typical reaction mixture to prepare n-butyl pyridinium chloroaluminate ionic liquid salt having an Al/N molar ratio of 2.0 is shown below:

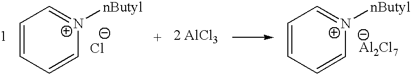

For the case of the above reaction, and for typical quaternary ammonium chloroaluminate salts, the molar ratio of Al to N cannot exceed 2.0 at room temperature for extended periods. This is because any additional AlCl₃ precipitates out and would not stay in the ionic liquid.

It has been discovered that the molar ratio of Al to N in the ionic liquid catalyst of this invention can be higher than what is possible in a freshly prepared quaternary ammonium chloroaluminate salt or alkyl pyridinium haloaluminate ionic liquid, which have a maximum molar ratio of Al to N of 2.0. In some embodiments the molar ratio of Al to N is greater than 2.1, greater than 2.5, or even greater than 2.8. In some embodiments the molar ratio of Al to N is less than 9, less than 8, less than 5, or less than 4. In one embodiment the molar ratio of Al to N is from 2.1 to 8; such as, for example, from 2.5 to 5.1 or from 2.5 to about 4.

In one aspect, the ionic liquid catalyst comprises an impurity in the catalyst that increases the catalyst's capacity to uptake more AlCl₃ in the catalyst phase. In one embodiment the catalyst comprises a conjunct polymer as an impurity which increases the catalyst's capacity to uptake AlCl₃. In this embodiment the level of the conjunct polymer is present in an amount that still enables the ionic liquid catalyst or catalyst system to perform its desired catalytic function.

The presence of the impurity is an advantage over other ionic liquid catalysts comprising an impurity, because the impurity in this embodiment does not significantly inactivate the catalyst. The ionic liquid catalyst remains effective to perform its desired catalytic function. The ionic liquid catalyst can be used for a hydrocarbon conversion without having to stop the reaction and regenerate the catalyst for an extended period.

In one embodiment, an advantage of the ionic liquid catalyst having a molar ratio of Al to N greater than 2.0 is that it continues to function effectively to convert the hydrocarbon, without becoming significantly deactivated by conjunct polymer. In this embodiment the acid catalyst can be used continuously without having to be removed from the reactor for an extended period, or the catalyst drainage can be reduced. In this embodiment the acid catalyst may be regenerated in part, such that only a portion of the acid catalyst is regenerated at a time and the hydrocarbon conversion process does not need to be interrupted. For example, a slip stream of the ionic liquid catalyst effluent can be regenerated and recycled to a hydrocarbon conversion reactor. In one embodiment the level of the conjunct polymer is maintained within a desired range by partial regeneration in a continuous hydrocarbon conversion process.

The level of the impurity (e.g., conjunct polymer) will generally be less than or equal to 30 wt %, but examples of other desired ranges of impurity in the ionic liquid catalyst or catalyst system are from 1 to 24 wt %, from 1 to 20 wt %, from 0.5 to 15 wt %, or from 0.5 to 12 wt %.

The term conjunct polymer was first used by Pines and Ipatieff to distinguish these polymeric molecules from typical polymers. Unlike typical polymers which are compounds formed from repeating units of smaller molecules by controlled or semi-controlled polymerizations, “conjunct polymers” are “pseudo-polymeric” compounds formed asymmetrically from two or more reacting units by concurrent acid-catalyzed transformations including polymerization, alkylation, cyclization, additions, eliminations and hydride transfer reactions. Consequently, the produced “pseudo-polymeric” may include a large number of compounds with varying structures and substitution patterns. The skeletal structures of “conjunct polymers”, therefore, range from the very simple linear molecules to very complex multi-feature molecules.

Some examples of the likely polymeric species in conjunct polymers were reported by Miron et al. (Journal of Chemical and Engineering Data, 1963), and Pines (Chem. Tech, 1982). Conjunct polymers are also commonly known to those in the refining industry as “red oils” due to their reddish-amber color or “acid-soluble oils” due to their high uptake in the catalyst phase where paraffinic products and hydrocarbons with low olefinicity and low functional groups are usually immiscible in the catalyst phase. In this application, the term “conjunct polymers” also includes ASOs (acid-soluble-oils) and red oils.

The level of conjunct polymer in the acid catalyst is determined by hydrolysis of known weights of the catalyst. An example of a suitable test method is described in Example 3 of commonly assigned U.S. Patent Publication Number US20070142213A1. Conjunct polymers can be recovered from the acid catalyst by means of hydrolysis. The hydrolysis recovery methods employ procedures that lead to complete recovery of the conjunct polymers and are generally used for analytical and characterization purposes because it results in the destruction of the catalyst. Hydrolysis of the acid catalyst is done, for example, by stirring the spent catalyst in the presence of excess amount of water followed by extraction with low boiling hydrocarbon solvents such as pentane or hexane. In the hydrolysis process, the catalyst salt and other salts formed during hydrolysis go into the aqueous layer while conjunct polymers go into the organic solvent. The low boiling solvent containing the conjunct polymers are concentrated on a rotary evaporator under vacuum and moderate temperature to remove the extractant, leaving behind the high boiling residual oils (conjunct polymers) which are collected and analyzed. The low boiling extractants can be also removed by distillation methods.

In one embodiment, the higher the level of conjunct polymer in the ionic liquid catalyst or catalyst system the higher is the molar ratio of Al to N. This is because the catalyst's capacity for uptake of AlCl₃ increases at higher conjunct polymer concentration in the catalyst phase.

In one embodiment, the solubility of incremental AlCl₃ above the 2.0 Al/N molar ratio in the ionic liquid catalyst or catalyst system is 3 wt % or higher at 50° C. or below. In other embodiments the solubility of incremental AlCl₃ above the 2.0 Al/N molar ratio in the ionic liquid catalyst or catalyst system is from 3 wt % to 20 wt %, or from 4 wt % to 15 wt % at 50° C. or below.

In one embodiment, the solubility of incremental AlCl₃ above the 2.0 Al/N molar ratio in the ionic liquid catalyst or catalyst system is significantly higher at 100° C. than at 50° C. For example the solubility of incremental AlCl₃ above the 2.0 Al/N molar ratio in the ionic liquid catalyst or catalyst system can be greater than 10 wt % at 100° C., such as from 12 to 50 wt %, from 12 to 40 wt %, or from 15 to 35 wt % at 100° C. In one embodiment the solubility of incremental AlCl₃ above the 2.0 Al/N molar ratio in the ionic liquid catalyst or catalyst system is at least 10 wt % higher at 100° C. than at 50° C.

In one embodiment, the AlCl₃ that is soluble and stable in the ionic liquid catalyst or catalyst system remains soluble in the ionic liquid catalyst or catalyst system. An example of this is where less than 0.1 wt %, less than 0.05 wt %, less than 0.01 wt %, or zero wt % AlCl₃ precipitates out of the ionic liquid catalyst or catalyst system when it is held for at least three hours at 25° C. or lower.

In one embodiment, the conjunct polymer is extractable. The conjunct polymer may be extracted during a catalyst regeneration process, such as by treatment of the catalyst with aluminum metal or with aluminum metal and hydrogen chloride. Examples of methods for regenerating ionic liquid catalysts are taught in U.S. Patent Publications US20070142215A1, US20070142213A1, US20070142676A1, US20070142214A1, US20070142216A1, US20070142211A1, US20070142217A1, US20070142218A1, US20070249485 A1, and in U.S. patent application Ser. Nos. 11/960,319, filed Dec. 19, 2007; 12/003,577, filed Dec. 28, 2007; 12/003,578, filed Dec. 28, 2007; 12/099,486, filed Apr. 8, 2008; and 61/118,215, filed Nov. 26, 2008.

In some embodiments the ionic liquid catalyst is useful for catalyzing a hydrocarbon conversion reaction. One example of a hydrocarbon conversion reaction is a Friedel-Crafts reaction. Other examples are alkylation, isomerization, hydrocracking, polymerization, dimerization, oligomerization, acylation, acetylation, metathesis, copolymerization, hydroformylation, dehalogenation, dehydration, olefin hydrogenation, and combinations thereof. For example, some of the ionic liquid catalysts are used for isoparaffin/olefin alkylation. Examples of ionic liquid catalysts and their use for isoparaffin/olefin alkylation are taught, for example, in U.S. Pat. Nos. 7,432,408 and 7,432,409, 7,285,698, and U.S. patent application Ser. No. 12/184,069, filed Jul. 31, 2008. High quality gasoline blending components and middle distillates can be made from these processes. In some embodiments the alkylate from the isoparaffin/olefin alkylation has a Research-method octane number (RON) of 86 or higher, or even 92 or higher. The RON is determined using ASTM D 2699-07a. Additionally, the RON may be calculated [RON (GC)] from gas chromatography boiling range distribution data.

The time the catalyst is held at a temperature at or below 25° C. can be fairly lengthy. In general, the time is for at least two hours, three hours or longer, up to two weeks, more than 50 days, several months, or even a year.

The alkyl-pyridinium haloaluminate may comprise a haloaluminate selected from the group consisting of chloroaluminate, fluoroaluminate, bromoaluminate, iodoaluminate, and mixtures thereof. In one embodiment, the alkyl- is methyl, ethyl, propyl, butyl, pentyl, or hexyl.

In one embodiment, the hydrogen chloride is at least partially produced from an alkyl chloride. In one embodiment, the hydrogen chloride increases the acidity, and thus the activity of the ionic liquid catalyst. In one embodiment, the hydrogen chloride, in combination with aluminum, assists in the conversion of the inactive anion AlCl₄⁻ to form the more acidic and effective chloroaluminate species for alkylation, such as AlCl₃, Al₂Cl₇⁻, or even Al₃Cl₁₀⁻. In some embodiments, the alkyl chloride is derived from the isoparaffin or olefin used in a given reaction. For example, with the alkylation of isobutene with butane in chloroaluminate ionic liquids, the alkyl chloride could be 1-butyl chloride, 2-butyl chloride, t-butyl chloride, or a mixture thereof. Other examples of alkyl chlorides that can be used are ethyl chloride, isopentyl chloride, hexyl chloride, or heptyl chloride. In one embodiment, the amount of the alkyl chloride should be kept at low concentrations and not exceed the molar concentration of the Lewis acid portion of the catalyst, AlCl₃. In one embodiment, the amounts of the alkyl chloride used may range from 0.05 mol % to 100 mol % of the Lewis acid portion of the ionic liquid catalyst, AlCl₃. The amount of the alkyl chloride can be adjusted to keep the acidity of the ionic liquid catalyst or ionic liquid catalyst system at the desired performing capacity. In another embodiment, the amount of the alkyl chloride is proportional to the olefin, and does not exceed the molar concentration of the olefin in the isoparaffin/olefin alkylation reaction.

Any term, abbreviation or shorthand not defined is understood to have the ordinary meaning used by a person skilled in the art at the time the application is filed. The singular forms “a,” “an,” and “the,” include plural references unless expressly and unequivocally limited to one instance.

All of the publications, patents and patent applications cited in this application are herein incorporated by reference in their entirety to the same extent as if the disclosure of each individual publication, patent application or patent was specifically and individually indicated to be incorporated by reference in its entirety.

This written description uses examples to disclose the invention, including the best mode, and also to enable any person skilled in the art to make and use the invention. Many modifications of the exemplary embodiments of the invention disclosed above will readily occur to those skilled in the art. Accordingly, the invention is to be construed as including all structure and methods that fall within the scope of the appended claims.

### EXAMPLES

### Example 1

An isobutane-butene alkylation catalyzed with butyl pyridinium chloroaluminate ionic liquid, and co-catalyzed with t-butyl chloride, was performed in a continuous liquid phase reactor. During the alkylation, the ionic liquid catalyst was continuously regenerated by mixing it with aluminum metal at 100° C. after each pass through the alkylation reactor. The aluminum metal regeneration treatment reactivated the catalyst by removing most of the conjunct polymers that accumulated as alkylation by-products in the catalyst phase and by making and re-making AlCl₃. The regeneration resulted in the formation of excess AlCl₃, depending on how much chloride sank into the catalyst phase from the alkyl chloride used as a co-catalyst.

The level of conjunct polymer in the ionic liquid catalyst was maintained between 2 and 23 wt % during the alkylation. Elemental analysis of the ionic liquid showed that the molar ratio of Al to N increased over time during the alkylation with no precipitation of excess AlCl₃ formed during the continuous generation cycles. The freshly prepared ionic liquid, with no conjunct polymer, had a molar ratio of Al to N of 2.0. During alkylation, the molar ratio of Al to N in the liquid catalyst increased to 2.1, and then to 2.5 and then to 4.0 when sampled over a period of fifty plus days. Even with a higher molar ratio of Al to N, the ionic liquid catalyst still remained effective for alkylation and produced an alkylate product with a RON greater than 92. The higher molar ratio of Al to N in the catalyst with conjunct polymer extended the life of the ionic liquid catalyst before it required complete regeneration.

### Example 2

The solubility of incremental AlCl₃ above the 2.0 Al/N molar ratio in the different samples of n-butyl pyridinium chloroaluminate ionic liquid catalyst with different levels of conjunct-polymer impurity were tested at four different temperatures. The solubility study results are summarized in Table 1, below.

TABLE 1

| | Incremental AlCl₃ Solubility, | | | |
|---|---|---|---|---|
| | Wt % | | | |
| | 25° C. | 50° C. | 75° C. | 100° C. |
| Fresh Catalyst with 0 wt % | 1.6 | 2 | 6.3 | 9.8 |
| Conjunct Polymer | | | | |
| Regenerated Catalyst with ~2 wt % | 4 | 8 | 22 | 26 |
| Conjunct Polymer | | | | |
| Regenerated Catalyst with 11 wt % | 8.4 | 9 | 22 | 29 |
| Conjunct Polymer | | | | |
| Spent Catalyst with 15 wt % | 9 | 10 | 24 | 33 |
| Conjunct Polymer | | | | |

All of the samples of catalyst comprising conjunct polymer had a solubility of incremental AlCl₃ in the ionic liquid catalyst that was at least 10 wt % higher at 100° C. than at 50° C. The samples, with various amounts of solubilized incremental AlCl₃, were moved to room temperature and observed over time for AlCl₃ precipitation. Room temperature was approximately 25° C. or below.

All of the incremental AlCl₃ that was initially soluble in the fresh catalyst precipitated out within two hours of standing at room temperature (e.g. at or below 25° C.). Approximately 75% of the incremental AlCl₃ that was originally soluble in the regenerated catalyst with ±2 wt % conjunct polymer precipitated out within 72 hours of standing at room temperature.

A slight amount of incremental AlCl₃ precipitated out of the regenerated catalyst with 11 wt % conjunct polymer when it was held at room temperature overnight. No substantial additional amount precipitated out over a two week period of standing at room temperature.

No precipitation was observed in the spent catalyst samples held at room temperature for over two weeks.

What is claimed is:

1. An ionic liquid system for an isoparaffin/olefin alkylation, comprising: a quaternary ammonium chloroaluminate, a conjunct polymer, and a hydrogen chloride; wherein the ionic liquid system has a molar ratio of Al to N from 2.1 to 8.0, and wherein less than 0.1 wt % AlCl₃ precipitates from the ionic liquid system when the ionic liquid system is held for three hours or longer at or below 25° C.

2. The ionic liquid system of claim 1, wherein no AlCl₃ precipitates from the ionic liquid system.

3. The ionic liquid system of claim 1, wherein the hydrogen chloride is at least partially produced from an alkyl chloride.

4. The ionic liquid system of claim 3, wherein the alkyl chloride is derived from an isoparaffin or an olefin used in the isoparaffin/olefin alkylation.

5. The ionic liquid system of claim 4, additionally comprising a reactor, wherein the reactor holds the quaternary ammonium chloroaluminate, the conjunct polymer, and the hydrogen chloride.

6. An alkylation reactor comprising an ionic liquid catalyst comprising an ammonium chloroaluminate salt, and having a molar ratio of Al to N greater than 2.0, when the ionic liquid catalyst is held at a temperature at or below 25° C. for at least two hours.

7. An alkylation reactor comprising an ionic liquid catalyst comprising an alkyl-pyridinium haloaluminate and an impurity, wherein the ionic liquid catalyst has a molar ratio of Al to N greater than 2.0 when the ionic liquid catalyst is held at a temperature at or below 25° C. for at least two hours.
